(19) United States
(12) Patent Application Publication
(10) Pub. No.: US 2025/0292078 A1
(43) Pub. Date: Sep. 18, 2025

(54) METHOD AND APPARATUS FOR GENERATING NEURAL NETWORK MODELS FOR MISSING VALUE RESTORATION

(71) Applicant: Electronics and Telecommunications Research Institute, Daejeon (KR)

(72) Inventor: Jaeik JEONG, Sejong-si (KR)

(73) Assignee: Electronics and Telecommunications Research Institute, Daejeon (KR)

(21) Appl. No.: 19/018,066

(22) Filed: Jan. 13, 2025

(30) Foreign Application Priority Data
Mar. 12, 2024 (KR) 10-2024-0034771

(51) Int. Cl. G06N 3/08; G06N 3/0455

(52) U.S. Cl. CPC G06N 3/08; G06N 3/0455

(57) ABSTRACT

An operating method of an electronic device may include preprocessing time series data including a first missing value, obtaining output data by inputting the preprocessed time series data into an autoencoder, and training the autoencoder based on the output data and the time series data. The preprocessed time series data may include the first missing value and a second missing value generated as a preprocessing result.

### CROSS-REFERENCE TO RELATED APPLICATION

This application claims the benefit of Korean Patent Application No. 10-2024-0034771 filed on Mar. 12, 2024, in the Korean Intellectual Property Office, the entire disclosure of which is incorporated herein by reference for all purposes.

### BACKGROUND

### 1. Field of the Invention

The following disclosure relates to a method and apparatus for generating neural network models for missing value restoration.

### 2. Description of the Related Art

A historical average (HA) method and a linear interpolation (LI) method are most widely used for missing value restoration. These methods may effectively restore missing values without a complicated learning process. The HA method restores a missing value by averaging values observed in a time zone that is highly correlated with the time zone of the missing value, such as data from a day ago or a day later. The HA method performs poorly if applied to a case where an energy consumption pattern is highly variable (e.g., a home or small building environment). The LI method restores a missing value by linearly connecting the last measured value before the missing value and the first measured value after the missing value. The LI method provides accurate results when short-term missing values occur or continuous missing values occur in a short period of time, but exhibits lower performance as missing values occur in a longer period of time.

Deep learning-based technology may be used for missing value restoration. In particular, a generative adversarial network (GAN)-based method is being established as a cutting-edge technology for missing value processing models. A GAN is specialized in generating data similar to actual data, and the GAN-based method may replace missing values with values restored to be similar to actual data. However, the GAN-based method is time-consuming and does not guarantee stable learning. The disadvantages of the GAN-based method are more prominent in an environment where the amount of training data is small and data includes numerous missing values.

An autoencoder, which is one of the unsupervised learning methods, may be used to increase learning speed and stability compared to GAN-based learning in missing value processing. A denoising autoencoder (DAE) may learn how to restore missing values based on original daily load profile (DLP) data that does not include missing values. Since complete DLP data is required to train the DAE, the DAE may be inappropriate in an environment where a sufficient amount of complete DLP data that does not include missing values is not collected. To solve this issue, a masked autoencoder (MAE) may be used. Unlike conventional autoencoders, the MAE does not touch missing values and only restores values other than the missing values during the reconstruction process. Instead, the MAE predicts missing values included in input DLP data based on patterns found in other DLP data sharing similarities with the input DLP data. However, the MAE does not involve a denoising process, which is a process for restoring missing values, and may thus exhibit quite low performance if it is difficult to find similar patterns.

The above information may be presented as the related art to help with the understanding of the disclosure. No arguments or decisions are made as to whether any of the above is applicable as a prior art related to the disclosure.

### SUMMARY

According to an aspect, there is provided an operating method of an electronic device, the operating method including preprocessing time series data including a first missing value, obtaining output data by inputting the preprocessed time series data into an autoencoder, and training the autoencoder based on the output data and the time series data. The preprocessed time series data may include the first missing value and a second missing value generated as a preprocessing result.

The autoencoder may be trained so that the output data may approximate the time series data including the first missing value instead of complete data that does not include missing values.

The second missing value may be generated based on a missing pattern appearing in an environment where the time series data is collected.

The output data may include a restored value for the first missing value and a restored value for the second missing value. The restored value for the first missing value may be excluded when training the autoencoder.

An objective function to train the autoencoder may include a parameter to exclude the restored value for the first missing value. The parameter may be set to “0” only for the first missing value.

The first missing value may be replaced with “0” when input into the autoencoder.

The autoencoder may be trained to minimize a mean squared error (MSE) between the output data and the time series data.

The time series data may include daily load data associated with energy usage. The objective function to train the autoencoder may satisfy the following equation,

$$\frac{1}{m} \cdot \frac{1}{{O}_{d}} {\sum }_{d = 1}^{m} {\sum }_{i = 1}^{n} {( {x}_{di} - {f ( {\tilde{x}}_{d} )}_{i} )}^{2} \cdot I .$$

Here, m denotes all dates constituting daily load data, O_{d} denotes the number of values other than missing values among values included in the daily load data, d denotes an index fora date, i denotes an index for a time range, n denotes the total number of time ranges constituting the daily load data, x_{di} denotes daily load data on a date d and in a time range i, \tilde{x}_{d} denotes a result of preprocessing daily load data x_{d}, f(\tilde{x}_{d})ₜ denotes daily load data in a time range i in an output of the autoencoder for x_{d}, and I denotes a parameter to exclude a restored value for the first missing value.

The second missing value may be replaced with “0” when input into the autoencoder.

According to an aspect, there is provided an electronic device including a processor, and a memory configured to store instructions. The instructions, when executed by the processor, may cause the electronic device to preprocess time series data including a first missing value, obtain output data by inputting the preprocessed time series data into an autoencoder, and train the autoencoder based on the output data and the time series data. The preprocessed time series data may include the first missing value and a second missing value generated as a preprocessing result.

The autoencoder may be trained so that the output data may approximate the time series data including the first missing value instead of complete data that does not include missing values.

The second missing value may be generated based on a missing pattern appearing in an environment where the time series data is collected.

The output data may include a restored value for the first missing value and a restored value for the second missing value. The restored value for the first missing value may be excluded when training the autoencoder.

An objective function to train the autoencoder may include a parameter to exclude the restored value for the first missing value. The parameter may be set to “0” only for the first missing value.

The first missing value may be replaced with “0” when input into the autoencoder.

The autoencoder may be trained to minimize an MSE between the output data and the time series data.

The time series data may include daily load data associated with energy usage. The objective function to train the autoencoder may satisfy the following equation,

$$\frac{1}{m} \cdot \frac{1}{{O}_{d}} {\sum }_{d = 1}^{m} {\sum }_{i = 1}^{n} {( {x}_{di} - {f ( {\tilde{x}}_{d} )}_{i} )}^{2} \cdot I .$$

Here, m denotes all dates constituting daily load data, O_{d} denotes the number of values other than missing values among values included in the daily load data, d denotes an index fora date, t denotes an index for a time range, n denotes the total number of time ranges constituting the daily load data, x_{di} denotes daily load data on a date d and in a time range i, \tilde{x}_{d} denotes a result of preprocessing daily load data x_{d}, f(\tilde{x}_{d})ᵢ denotes daily load data in a time range Z in an output of the autoencoder for x_{d}, and I denotes a parameter to exclude a restored value for the first missing value.

The second missing value may be replaced with “0” when input into the autoencoder.

According to an aspect, there is provided an operating method of an electronic device, the operating method including obtaining daily load data that is associated with energy usage and includes a missing value, and restoring the missing value by inputting the daily load data into an autoencoder. The autoencoder may be trained to approximate data including missing values instead of complete data that does not include missing values.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram of an electronic device according to an embodiment;

FIG. 2 is a diagram illustrating an autoencoder according to an embodiment;

FIG. 3 is a flowchart illustrating an autoencoder training operation of an electronic device according to an embodiment;

FIGS. 4A and 4B are diagrams illustrating an autoencoder training operation of an electronic device according to an embodiment; and

FIG. 5 is a flowchart illustrating a trained autoencoder-based missing value restoration operation of an electronic device according to an embodiment.

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context dearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The term “module” used herein may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an application-specific integrated circuit (ASIC), and a “unit” performs predefined functions. However, the term “unit” is not limited to software or hardware. A “unit” may be configured to reside on an addressable storage medium or configured to operate one or more processors. For example, the term “unit” may include components, such as software components, object-oriented software components, class components, and task components, processes, functions, attributes, procedures, sub-routines, segments of program code, drivers, firmware, microcode, circuitry, data, databases, data structures, tables, arrays, and variables. The functionality provided by the components and “units” may be combined into fewer components and “units” or further separated into additional components and “units”. Furthermore, the components and “units” may be implemented to operate one or more central processing units (CPUs) within a device or a security multimedia card. In addition, a “unit” may include one or more processors.

Hereinafter, embodiments will be described in detail with reference to the accompanying drawings. When describing the embodiments with reference to the accompanying drawings, like reference numerals refer to like components, and any repeated description related thereto will be omitted.

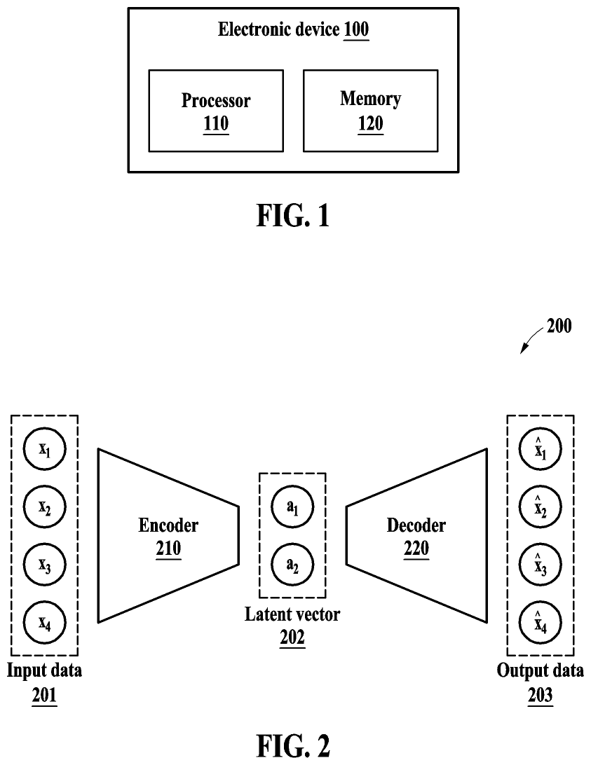

FIG. 1 is a block diagram of an electronic device according to an embodiment.

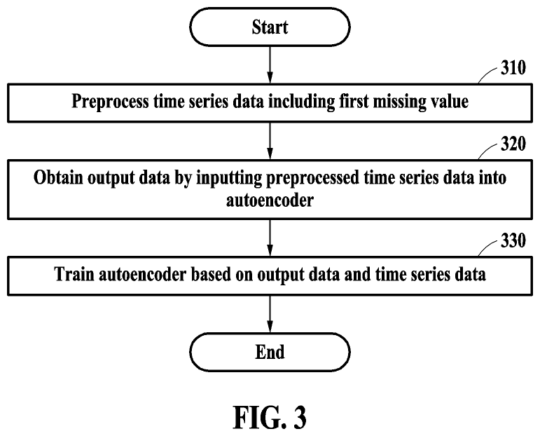

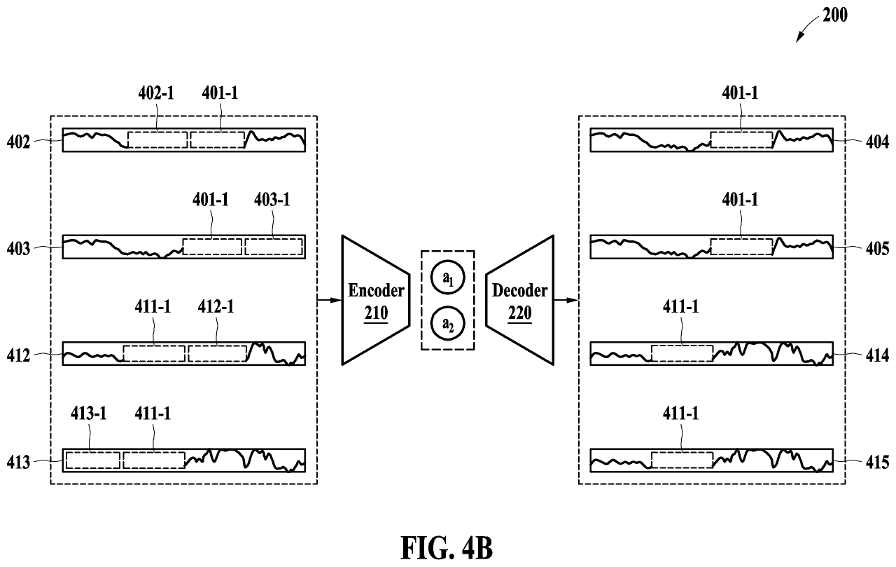

Referring to FIG. 1, an electronic device 100 according to an embodiment may restore a missing value included in time series data. The electronic device 100 may use an autoencoder (e.g., an autoencoder 200 of FIG. 2) for missing value restoration. The electronic device 100 may train the autoencoder for missing value restoration (e.g., See FIGS. 4A and 4B).

According to an embodiment, when training the autoencoder, the electronic device 100 may generate an additional missing value (e.g., a second missing value) by preprocessing the time series data including the missing value (e.g., a first missing value). The electronic device 100 may then input the preprocessed data including the first missing value and the second missing value into the autoencoder. The electronic device 100 may train the autoencoder to minimize the mean squared error (MSE) between output data of the autoencoder for the preprocessed data and the time series data including the missing value (e.g., the first missing value). That is, the autoencoder may be trained so that output data approximates time series data including missing values instead of complete data that does not include missing values.

According to an embodiment, the electronic device 100 may efficiently train the autoencoder even in an environment where the amount of training data is small and a large amount of data includes missing values compared to complete data. The electronic device 100 may integrate the benefits of a denoising autoencoder (DAE)-based missing processing process with the benefits of masked autoencoder (MAE)-based similarity identification learning. The electronic device 100 may restore missing values with high accuracy for daily load data (e.g., a daily load profile (DLP)) associated with energy usage.

As described above, the electronic device 100 may restore missing values using a neural network (e.g., the autoencoder). The neural network may refer to an overall model in which artificial neurons (nodes) forming a network by combining synapses have a problem-solving ability by changing the strength of the synaptic connection through learning.

According to an embodiment, the neurons of the neural network may include a combination of weights or biases. The neural network may include one or more layers including one or more neurons or nodes. The neural network may infer results to be predicted from predetermined inputs by changing the weights of the neurons through learning.

According to an embodiment, the neural network may include a deep neural network. The neural network may include a convolutional neural network (CNN), a recurrent neural network (RNN), a perceptron, a multilayer perceptron, a feedforward (FF) network, a radial basis network (RBF), a deep feedforward (DFF) network, a long short-term memory (LSTM), a gated recurrent unit (GRU), an automatic encoder (AE), a variational automatic encoder (VAE), a denoising automatic encoder (DAE), a sparse automatic encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN). The structure of the neural network (e.g., the autoencoder) implemented in the electronic device 100 will be described in detail with reference to FIG. 2.

According to an embodiment, the electronic device 100 may be implemented in a personal computer (PC), a data server, or a portable device.

According to an embodiment, the portable device may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal or portable navigation device (PND), a handheld game console, an e-book, or a smart device. The smart device may be implemented as a smart watch, a smart band, or a smart ring.

According to an embodiment, the electronic device 100 may indude a processor 110 and a memory 120.

According to an embodiment, the processor 110 may process data stored in the memory 120. The processor 110 may execute computer-readable code (e.g., software) stored in the memory 120 and instructions triggered by the processor 110.

According to an embodiment, the processor 110 may be a hardware-implemented data processing device having a circuit that is physically structured to execute desired operations. The desired operations may include, for example, code or instructions included in a program.

According to an embodiment, the hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

According to an embodiment, the memory 120 may be implemented as a volatile memory device or a non-volatile memory device.

According to an embodiment, the volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM).

According to an embodiment, the non-volatile memory device may be implemented as an electrically erasable programmable read-only memory (EEPROM), a flash memory, a magnetic RAM (MRAM), a spin-transfer torque (STT)-MRAM, a conductive bridging RAM(CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), or an insulator resistance change memory.

According to an embodiment, the electronic device 100 may preprocess the time series data including the first missing value. The preprocessed time series data may include the first missing value and the second missing value generated as a preprocessing result. The operation of preprocessing time series data will be described in detail with reference to FIG. 4A.

According to an embodiment, the electronic device 100 may obtain output data by inputting the preprocessed time series data into the autoencoder. The electronic device 100 may train the autoencoder based on the output data and the time series data. The operation of training the autoencoder will be described in detail with reference to FIG. 4B.

FIG. 2 is a diagram illustrating an autoencoder according to an embodiment.

Referring to FIG. 2, the internal configuration of an autoencoder 200 according to an embodiment is shown. The autoencoder 200 may include an encoder 210 and a decoder 220. The autoencoder 200 may perform compression and restoration of input data 201.

According to an embodiment, the encoder 210 may receive the input data 201.

The input data 201 may include missing values, as preprocessed data. The encoder 210 may output a latent vector 202 (e.g., a feature vector) based on the input data 201. The latent vector 202 may have smaller dimensions than the input data 201. The encoder 210 may perform compression while preserving information in the input data 201 as much as possible.

According to an embodiment, the decoder 220 may receive the latent vector 202. The decoder 220 may generate output data 203 based on the latent vector 202. The output data 203 may restore at least a portion of the missing values included in the input data 201.

Typically, a decoder (e.g., the decoder 220) may output data (e.g., the output data 203) configured to approximate (e.g., equalize) input data (e.g., the input data 201) based on a latent vector (e.g., the latent vector 202). However, the decoder 220 according to an embodiment may be configured to approximate data before preprocessing (e.g., time series data 401 of FIG. 4A) instead of the input data 201 of the encoder 210 (e.g., preprocessed data) (e.g., preprocessed time series data 402 of FIG. 4A) (see FIG. 4B).

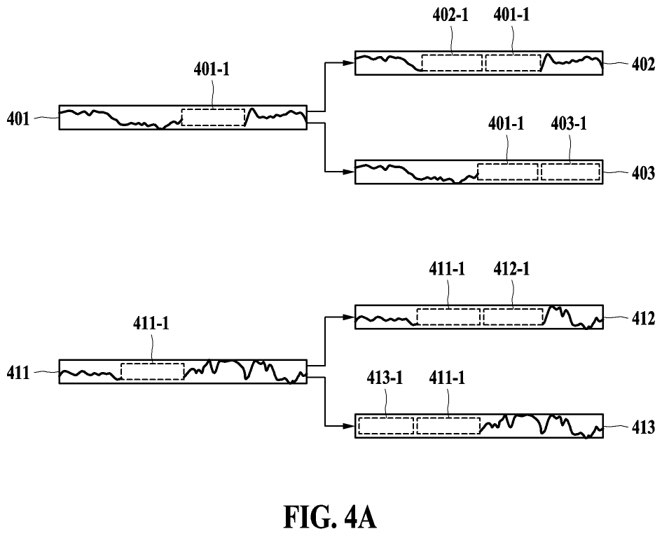

FIG. 3 is a flowchart illustrating an autoencoder training operation of an electronic device according to an embodiment, and FIGS. 4A and 4B are diagrams illustrating an autoencoder training operation of an electronic device according to an embodiment.

Referring to FIG. 3, according to an embodiment, operations 310 to 330 may be at least part of the operation of training an autoencoder (e.g., the autoencoder 200 of FIG. 2) by an electronic device (e.g., the electronic device 100 of FIG. 1). Operations 310 to 330 may be performed sequentially, but are not necessarily performed sequentially. For example, the order of operations 310 to 330 may be changed, or at least two operations thereof may be performed in parallel.

According to an embodiment, operations 310 to 330 may be performed by a processor (e.g., the processor 110 of FIG. 1) of the electronic device 100.

In operation 310, the electronic device 100 according to an embodiment may preprocess time series data including a first missing value.

Referring to FIG. 4A, according to an embodiment, the electronic device 100 may preprocess time series data 401 and 411. The time series data 401 (e.g., original data) may include a missing value (e.g., a first missing value 401-1) (e.g., an initial missing value). The electronic device 100 may generate preprocessed time series data 402 and 403 by preprocessing the time series data 401. The preprocessed time series data 402 may include the first missing value 401-1 and an additional missing value (e.g., a second missing value 402-1) generated as a preprocessing result. The preprocessed time series data 403 may also include the first missing value 401-1 and a second missing value 403-1. The second missing values 402-1 and 403-1 may be generated before and after the first missing value 401-1. Each of the second missing values 402-1 and 403-1 (e.g., the additional missing values) may be generated based on a missing pattern appearing in an environment where the time series data 401 (e.g., the original data) is collected, and is not limited to before and after the first missing value 401-1 (e.g., the initial missing value).

According to an embodiment, the time series data 411 (e.g., original data) may include a first missing value 411-1 (e.g., an initial missing value). The electronic device 100 may generate preprocessed time series data 412 and 413 by preprocessing the time series data 411. The preprocessed time series data 412 may include the first missing value 411-1 and an additional missing value (e.g., a second missing value 412-1) generated as a preprocessing result. The preprocessed time series data 413 may also include the first missing value 411-1 and a second missing value 413-1. The second missing values 412-1 and 413-1 may be generated before and after the first missing value 411-1. Each of the second missing values 412-1 and 413-1 may be generated based on a missing pattern appearing in an environment where the time series data 411 is collected, and is not limited to before and after the first missing value 411-1.

In operation 320, the electronic device 100 according to an embodiment may obtain output data by inputting the preprocessed time series data into the autoencoder 200.

Referring to FIG. 4B, according to an embodiment, the electronic device 100 may obtain output data 404 by inputting the preprocessed time series data 402 into the autoencoder 200. The first missing value 401-1 on the preprocessed time series data 402 may be masked. The second missing value 402-1 on the preprocessed time series data 402 may be replaced with “0” and input into the encoder 210. The decoder 220 may not restore the masked first missing value 401-1, and may restore only the second missing value 402-1 replaced with “0”. At this time, the output data 404 may include only the restored value for the second missing value 402-1.

However, according to an embodiment, rather than masking the first missing value 401-1, the decoder 220 may restore the first missing value 401-1 as well and exclude the restored value for the first missing value 401-1 when training the autoencoder 200. In this case, the first missing value 401-1 may be replaced with “0” and input into the encoder 210, and the output data 404 of the decoder 220 may include the restored value for the first missing value 401-1 and the restored value for the second missing value 402-1. However, as described above, the restored value for the first missing value 401-1 may be excluded when training the autoencoder 200.

According to an embodiment, the electronic device 100 may obtain output data 405, 414, and 415 by inputting the preprocessed time series data 403, 412, and 413 into the autoencoder 200. Since the method of obtaining the output data 405, 414, and 415 is substantially similar to the method of obtaining the output data 404, a detailed description thereof will be omitted.

In operation 330, the electronic device 100 according to an embodiment may train the autoencoder 200 based on the output data and the time series data. The autoencoder 200 may be trained so that output data (e.g., the output data 404) may approximate time series data (e.g., the time series data 401) (e.g., daily load data associated with energy usage) including a first missing value (e.g., the first missing value 401-1) instead of complete data that does not include missing values. An objective function to train the autoencoder 200 may be expressed by Equation 1.

$$\frac{1}{m} \cdot \frac{1}{{O}_{d}} {\sum }_{d = 1}^{m} {\sum }_{i = 1}^{n} {( {x}_{di} - {f ( {\tilde{x}}_{d} )}_{i} )}^{2} \cdot I \qquad [ Equation 1 ]$$

In Equation 1, m denotes all dates constituting daily load data, O_{d} denotes the number of values other than missing values among values included in the daily load data, d denotes an index for a date, i denotes an index for a time range, n denotes the total number of time ranges constituting the daily load data, x_{di} denotes daily load data on a date d and in a time range i, \tilde{x}_{d} denotes a result of preprocessing daily load data denotes daily load data in a time range t in an output of the autoencoder for x_{d}, and I denotes a parameter to exclude a restored value for the first missing value. I may be set to “0” if x_{di} is “0” (e.g., only for the first missing value included in the daily load data x_{di})

According to an embodiment. Equation 1 may include a parameter I to exclude the restored value for the first missing value. As described above, if the first missing value is masked and not restored, the parameter I may be excluded from Equation 1. Referring to Equation1, the autoencoder 200 may be trained to minimize the MSE between the output data f(\tilde{x}_{d})ᵢ and the time series data x_{di}

According to an embodiment, since the autoencoder 200 is trained so that the output data approximates the time series data including the first missing value instead of complete data that does not include missing values, training the autoencoder 200 may require only a small amount of data (e.g., the complete data that does not include missing values). Thus, the electronic device 100 may efficiently train the autoencoder even in an environment where the amount of training data is small and a large amount of data includes missing values compared to complete data.

According to an embodiment, referring to Equation 1, the electronic device 100 may integrate the benefits of the DAE-based missing processing process and the MAE-based similarity identification learning. The electronic device 100 may restore the missing value included in the time series data based on the trained autoencoder.

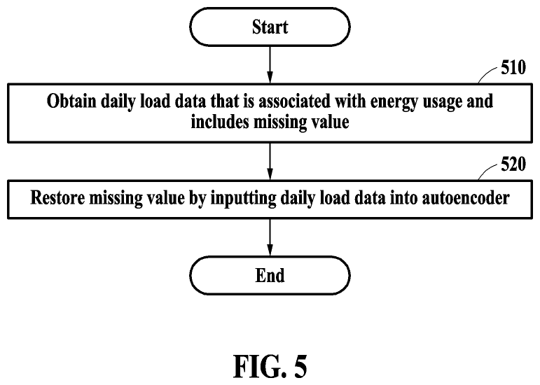

FIG. 5 is a flowchart illustrating a trained autoencoder-based missing value restoration operation of an electronic device according to an embodiment.

Referring to FIG. 5, according to an embodiment, operations 510 and 520 may be at least part of the operation of restoring a missing value based on an autoencoder by an electronic device. Operations 510 and 520 may be sequentially performed, but are not necessarily performed sequentially. For example, the order of operations 510 and 520 may be changed, or the two operations may be performed in parallel.

According to an embodiment, operations 510 and 520 may be performed by a processor (e.g., the processor 110 of FIG. 1) of an electronic device (e.g., the electronic device 100 of FIG. 1).

In operation 510, the electronic device 100 according to an embodiment may obtain daily load data that is associated with energy usage and includes a missing value.

In operation 520, the electronic device 100 according to an embodiment may restore the missing value by inputting the daily load data into the autoencoder. The autoencoder may be trained to approximate data including missing values instead of complete data that does not include missing values. However, the trained autoencoder may restore all missing values included in the daily load data. The electronic device 100 may restore missing values with high accuracy for the daily load data associated with energy usage.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular, however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice

A number of example embodiments have been described above. Nevertheless, it should be understood that various modifications may be made to these example embodiments. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. An operating method of an electronic device, the operating method comprising:
preprocessing time series data comprising a first missing value;
obtaining output data by inputting the preprocessed time series data into an autoencoder, and
training the autoencoder based on the output data and the time series data,
wherein the preprocessed time series data comprises the first missing value and a second missing value generated as a preprocessing result.

2. The operating method of claim 1, wherein the autoencoder is trained so that the output data approximates the time series data comprising the first missing value instead of complete data that does not comprise missing values.

3. The operating method of claim 1, wherein the second missing value is generated based on a missing pattern appearing in an environment where the time series data is collected.

4. The operating method of claim 1, wherein
the output data comprises a restored value for the first missing value and a restored value for the second missing value, and
the restored value for the first missing value is excluded when training the autoencoder.

5. The operating method of claim 4, wherein
an objective function to train the autoencoder comprises a parameter to exclude the restored value for the first missing value, and
the parameter is set to “0” only for the first missing value.

6. The operating method of claim 1, wherein the first missing value is replaced with “0” when input into the autoencoder.

7. The operating method of claim 1, wherein the autoencoder is trained to minimize a mean squared error (MSE) between the output data and the time series data.

8. The operating method of claim 1, wherein
the time series data comprises daily load data associated with energy usage, and
the objective function to train the autoencoder satisfies the following equation,
$$\frac{1}{m} \cdot \frac{1}{{O}_{d}} {\sum }_{d = 1}^{m} {\sum }_{i = 1}^{n} {( {x}_{di} - {f ( {\tilde{x}}_{d} )}_{i} )}^{2} \cdot I ,$$
where m denotes all dates constituting daily load data, O_{d} denotes the number of values other than missing values among values included in the daily load data, d denotes an index for a date, i denotes an index for a time range, n denotes the total number of time ranges constituting the daily load data, di denotes daily load data on a date d and in a time range i, \tilde{x}_{d} denotes a result of preprocessing daily load data x_{d}, f(\tilde{x}_{d})ᵢ denotes daily load data in a time range i in an output of the autoencoder for x_{d}, and I denotes a parameter to exclude a restored value for the first missing value.

9. The operating method of claim 1, wherein the second missing value is replaced with “0” when input into the autoencoder.

10. A non-transitory computer-readable storage medium storing instructions that, when executed by a processor, cause the processor to perform the operating method of claim 1.

11. An electronic device comprising:
a processor, and
a memory configured to store instructions,
wherein the instructions, when executed by the processor, cause the electronic device to:
preprocess time series data comprising a first missing value,
obtain output data by inputting the preprocessed time series data into an autoencoder, and
train the autoencoder based on the output data and the time series data,
wherein the preprocessed time series data comprises the first missing value and a second missing value generated as a preprocessing result.

12. The electronic device of claim 11, wherein the autoencoder is trained so that the output data approximates the time series data comprising the first missing value instead of complete data that does not comprise missing values.

13. The electronic device of claim 11, wherein the second missing value is generated based on a missing pattern appearing in an environment where the time series data is collected.

14. The electronic device of claim 11, wherein
the output data comprises a restored value for the first missing value and a restored value for the second missing value, and
the restored value for the first missing value is excluded when training the autoencoder.

15. The electronic device of claim 14, wherein
an objective function to train the autoencoder comprises a parameter to exclude the restored value for the first missing value, and
the parameter is set to “0” only for the first missing value.

16. The electronic device of claim 11, wherein the first missing value is replaced with “0” when input into the autoencoder.

17. The electronic device of claim 11, wherein the autoencoder is trained to minimize a mean squared error (MSE) between the output data and the time series data.

18. The electronic device of claim 11, wherein
the time series data comprises daily load data associated with energy usage, and
the objective function to train the autoencoder satisfies the following equation,
$$\frac{1}{m} \cdot \frac{1}{{O}_{d}} {\sum }_{d = 1}^{m} {\sum }_{i = 1}^{n} {( {x}_{di} - {f ( {\tilde{x}}_{d} )}_{i} )}^{2} \cdot I ,$$
where m denotes all dates constituting daily load data, O_{d} denotes the number of values other than missing values among values included in the daily load data, d denotes an index for a date, t denotes an index for a time range, n denotes the total number of time ranges constituting the daily load data, x_{di} denotes daily load data on a date d and in a time range i, \tilde{x}_{d} denotes a result of preprocessing daily load data x_{d}, f(\tilde{x}_{d})ᵢ denotes daily load data in a time range t in an output of the autoencoder for x_{d}, and I denotes a parameter to exclude a restored value for the first missing value.

19. The electronic device of claim 11, wherein the second missing value is replaced with “0” when input into the autoencoder.

20. An operating method of an electronic device, the operating method comprising:
obtaining daily load data that is associated with energy usage and comprises a missing value; and
restoring the missing value by inputting the daily load data into an autoencoder,
wherein the autoencoder is trained to approximate data comprising missing values instead of complete data that does not comprise missing values.
